(19) United States
(12) Patent Application Publication
(10) Pub. No.: US 2012/0106418 A1
(43) Pub. Date: May 3, 2012

(54) CLIENT' DEVICE POWER REDUCTION IN WIRELESS NETWORKS HAVING NETWORK-COMPUTED CLIENT' LOCATION

(75) Inventors: ARITON E. XHAFA, PLANO, TX (US); DERIC WAYNE WATERS, DALLAS, TX (US); RAMANUJA VEDANTHAM, ALLEN, TX (US)

(73) Assignee: TEXAS INSTRUMENTS INCORPORATED, Dallas, TX (US)

(21) Appl. No.: 13/282,707

(22) Filed: Oct. 27, 2011

Related U.S. Application Data
(60) Provisional application No. 61/407,634, filed on Oct. 28, 2010.

(51) Int. Cl. H04W 52/02; H04W 24/00; G08C 19/00

(52) U.S. Cl. 370/311

(57) ABSTRACT

A method of reducing client power consumption in a wireless network including a network server which provides computed client' locations, at least one access point (AP), and a plurality of wireless stations (STAs) including a first wireless station (STA1). The AP periodically sends beacon frames that span a beacon period, wherein at least a first beacon frame is sent during the beacon period. The STA1 sends a location request frame to the AP requesting a STA1 location. During the beacon period the STA1 wakes up from a powersave (PS) mode or a sleep mode and sends a PSPoll frame to the AP. Responsive to the PSPoll frame, the AP replies with a priority response being a data frame including a location response packet including the STA1 location or a Null frame if the STA1 location is not available.

### CROSS REFERENCE TO RELATED APPLICATIONS

This application claims the benefit of Provisional Application Ser. No. 61/407,634 entitled “Reducing Power Consumption in CCX, filed Oct. 28, 2010, which is herein incorporated by reference in its entirety.

### FIELD

Disclosed embodiments are directed, in general, to wireless communication systems, and more specifically to wireless networks having network-computed client' location information.

### BACKGROUND

As wireless technologies proliferate, wireless networks serving a plurality of wireless devices referred to herein as wireless stations (STAs) have incorporated a multiplicity of different wireless standards. In some scenarios, the STAs need to know its position/location (hereafter its location) so that the STA can use the location information, indoor navigation and applications that make use of location information. In scenarios where the STAs cannot receive Global Positioning System (GPS) signals, access points (APs) can be useful since their location is fixed and known. APs connect computers or other wireless devices together to create a wireless network. Most wireless APs also function as a network bridge that connects the Wi-Fi network to a wired network such as Ethernet. Hence, STAs ask for the AP to provide them with their location information, which can be calculated (e.g., by a network server) using a packet received from the STA by one or more APs along with the AP location information.

Cisco Compatible Extensions (CCX) is a proprietary protocol developed by Cisco Systems, Inc. for network communications involving client devices (STAs). CCX contains positioning protocols that enable the wireless network to compute the physical location of the respective STAs. An example wireless network is a wireless local area network (“WLAN”), such as IEEE 802.11n.

CCX positioning protocols include what is referred to as S60 and S69. In S60, the STAs are configured to periodically (e.g., once every 60 seconds) broadcast path-loss measurement (PLM) frames. The APs in the network process the PLM packets and send the PLM-based data generally to a central network server which estimates the STA' location. In S60, the STA's do not receive this location information. The location information is instead consumed by the network layer itself for various applications. The S69 protocol enables the STA to obtain its location from the network. The STA can obtain its location information from the network using on-demand or subscription services. However, on-demand is what is typically used to obtain the location information.

FIG. 1 is a timing diagram 100 showing the workings of a known power save poll (PSPoll) mechanism. The AP periodically sends beacon packets to announce their presence at regular intervals, such as a default beacon interval of 100 milliseconds, with an example beacon packet shown in FIG. 1 being sent at time t_{1.} The beacon is shown including a traffic indication map (TIM) informing the STAs in the network that are in power save (PS) mode whether there are buffered packets available for them.

If a node in the network such as STA1 learns from the TIM that the AP has buffered data packets for it, at time t₂ the STA1 can transmit a PSPoll frame to the AP. PSPoll frames are sent by STAs to begin a process to “retrieve” packets queued at the AP for the STAs. A PSPoll frame indicates to the AP that a particular STA is awake to receive frames and will be awake (and listening) until it receives at least one frame. While the STA is listening for a packet to arrive, most of the radio receiver must be turned on, so power consumption is high compared to PS-mode, such as 110 mW and 46 mW, for WLAN and Bluetooth devices, respectively. The duration of the PSPoll frame can depend on the number of active-mode STAs present in the network, as well as the number of PS-mode STAs informed via the TIM. STA1 could be awake and listening after receiving the TIM indication or STA1 could start listening around t₂, generally slightly before sending the PSPoll frame since some time is needed by the STA1 to prepare and send the PSPoll frame.

After the AP receives the PSPoll frame sent by STA1, following the short interframe space (SIFS) time interval shown, the AP can respond at the time shown as t₃ to the PSPoll frame with an optional acknowledgment (ACK). Thereafter, at a time shown at t₄ the AP can send a response frame that includes location information for STA1 by sending at least one buffered data packet shown as MPDU1 to the STA1. MPDU1 comprises single or aggregated medium access control (MAC) protocol data unit (A-MPDU) packets, although the buffered data packet(s) can comprise other aggregated packet units. Although not shown, to conserve STA' power the AP can also send a buffered data packet directly to the STA1 promptly after receiving the PSPoll (without sending the ACK first). Following the SIFS shown in FIG. 1, at time t₅ the STA1 can send an ACK to AP.

The wait time for STA1 is largely the time interval shown as t₆ which precedes the sending of the MPDU1 provided by the AP. The conventional way that APs handle the response frame to a PSPoll is with significant delay due to queuing the response frame at the end of the queue of the packet transmission buffers before its transmission. Thus, for the known PSPoll mechanism, STA1 has to listen (be awake) while waiting for the MPDU1 from AP through the full time interval from t₂ to t₄. This wait time can be about 100 beacon intervals (e.g., 5 to 10 seconds).

### SUMMARY

Disclosed embodiments recognize wireless communication systems that include protocols that feature network-computed client wireless station' (STA) location, such as the CCX protocol described above, is power inefficient for the STA. Such embodiments recognize the main reason for the power inefficiency is that there no scheduling for the network response from the AP to an on-demand location request from STAs in the network. As disclosed above, since the network response to an on-demand location request from the STA can be significantly delayed, such as for 5 to 10 seconds, if the STA continuously listens for such intervals of time while waiting for the network's response, for many practical applications too much of the STA' power would be consumed while listening.

Disclosed embodiments prioritize the response by the AP to a PSPoll from a STA, with the priority response comprising a data frame including a data frame comprising a location response packet including the STA1 location, or Null frame if the STA1 location is not available (e.g., when the STA1 did not hear a beacon before the PSPoll is sent). The STAs can comprise a variety of different devices such as a smart phone, laptop or handheld device. The network can optionally include a soft-AP besides the AP, where a soft-AP is a STA in a P2P network (peer-to-peer networks) that also acts as the AP (thus, soft-AP or group-owner).

In the instance the priority response is a data frame including a location response packet including the STA1 location, the location response packet can be inserted at the “head of the queue”, and thus be the first to be transmitted in that access category, or the location response packet can be inserted in the queue based on the time of arrival of the PSPoll at the AP hence provide prompter delivery since packets in a given access category are sent first-in-first-out and the arrival time at the medium access control (MAC) layer that defines their position in the queue. If the PSPoll is sent before hearing a beacon TIM, the priority response may also be a Null frame.

One disclosed embodiment comprises a method of reducing client power consumption in a wireless network including a network server which provides computed client' locations, at least one AP, and a plurality of STAs including a first wireless station (STA1). The AP periodically sends beacon frames that span a beacon period, wherein at least a first beacon frame is sent during the beacon period. The STA1 sends a location request frame to the AP requesting a STA1 location. During the beacon period the STA1 wakes up from a PS-mode or a sleep mode and sends a PSPoll frame to the AP. Responsive to the PSPoll frame, the AP replies with a priority response being a data frame including a data frame comprising a location response packet including the STA1 location or a Null frame if the STA1 location is not available.

### BRIEF DESCRIPTION OF THE DRAWINGS

FIG. 1 is a timing diagram showing the workings of a known PSPoll mechanism.

FIG. 2 is an example timing diagram showing protocol behavior if the latest location information at the AP is not available when it initially receives a PLM packet from a STA, according to an example embodiment.

FIG. 3A is a block diagram representation of an example AP or soft-AP including a wireless transceiver and a disclosed location request scheduler for responding to a PSPoll frame from a STA that provides a priority response including a data frame comprising a location response packet including network-computed STA' location or a Null frame when the STA' location is not available for reducing STA' power consumption while waiting for the response, according to an example embodiment.

FIG. 3B is a block diagram depiction of an example wireless network that includes an AP and an optional soft-AP that each include a disclosed location request scheduler for responding to a PSPoll frame from a STA that provide a priority response for reducing STA' power consumption while waiting for the response according to an example embodiment.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

Disclosed embodiments include methods for reducing power consumption caused by slow on-demand network' response to a STA' location request. As described above, wireless communication protocols such as the CCX protocol are not friendly in terms of client'/STA' power consumption due to lack of scheduling for the location response packet response to an on-demand location request from the STA.

Disclosed embodiments largely solve this power consumption problem by having the STAs use a PS mechanism while participating in the network, and having the AP include a location request scheduler that prioritizes the location response packet following PSPoll receipt at the AP. The priority location response packet reduces listening time and thus power consumption for the STAs as compared to protocols in a legacy network.

An example power saving protocol for STAs obtaining location information from a wireless network is now described. In step 1, the STA may optionally send PLM packets periodically, such as every 60 seconds per the S60 protocol. In step 2, if the STA decides to get an updated location estimation, the STA in step 2(a) sends a fresh PLM packet so that the APs have fresh location information. In step 2(b) the STA sends a location request to the network, such as using S69 protocol. In step 2(c) the AP can respond “immediately” which can comprise the AP giving the highest priority to the STA' request and inserting the frame containing the latest location information for the requesting STA to the head of the transmission queue of the corresponding access category. If no STA1 location information is available, the AP can immediately send a Null frame. The reason why a Null frame may be transmitted instead of a location response packet is because the location response from the network server may not have yet reached the AP and the STA did not wait for a beacon TIM, rather it woke up and transmitted a PSPoll. Hence, the AP can reply with a Null frame.

One priority methodology is to insert the Null frame or data frame at the head of the queue corresponding to the access category associated with the Null frame or data frame. In IEEE802.11, for example, there are 4 different access categories. Inserting at the head of the queue will ensure a minimum amount of delay for the packet to be transmitted from the AP to the STA in PS mode response to PSPoll. The wait time described below in FIG. 2 is largely associated with the intervals t₁₄ to t₁₆ (which includes t₃₁ which is from the end of the ACK beginning at t₁₅ to t₁₆)and t₁₈ to t₂₀ (which includes t₃₂ which is from the end of the ACK beginning at t₁₉ to t₂₀).

In step 2(d), if the STA1 location information is stale or a Null frame is returned (the time stamp is when the location was computed, if it is prior to when the last PLM was transmitted, then it is stale), the STA can sleep for a period of time, such as for X seconds (shown as the “X-time interval” in FIG. 2 below from the end of ACK packet transmitted from STA1 at time t₁₇ to t₁₈), and go to step 2(b); location request again and repeat. If the location information is not stale, the STA can consume (get and process) the location information provided by the AP and then go to optional step 1 (sending PLM packet) and repeat. For example, “consuming” the application can comprise other applications using the location information for a variety of purposes. Else, the protocol can go directly to step 1 (sending PLM packet) and the sequence repeated, or it can go to sleep and give the network more time to compute the location in which case it would return to step 2(b) and repeat.

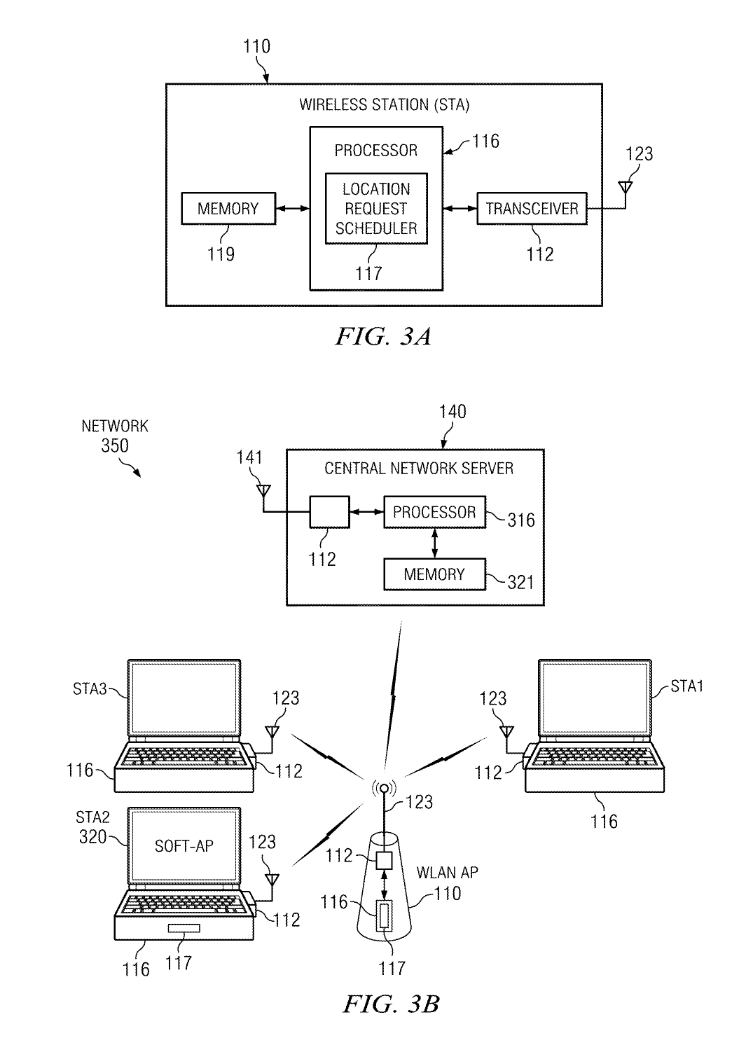

FIG. 2 is an example timing diagram 200 showing an example of disclosed protocol behavior when the latest location information at the AP is not available when the AP initially receives a PLM packet from a STA, according to an example embodiment. Timing diagram 200 can be applicable to network 350 shown in FIG. 3B described below. At time t₁₁, the AP sends a first beacon that is before the STA1 sends the PLM packet. The first beacon can include a TIM informing the STAs in the network that are in PS mode whether there are buffered packets available for them. However, the first beacon does not necessarily have to have a TIM for the STAs in the network including STA1 to be sent. At time t₁₂, the STA1 sends a PLM packet. By sending the PLM packet STA1 enables the network to compute its location information. At time t₁₃, the AP can send an ACK.

At t₁₄ the STA1 transmits a PSPoll frame. At t₁₅ the AP sends an optional ACK. Since the latest location information for STA1 at the AP is not available, the AP sends a Null frame at time t₁₆ as described above. To minimize listening time for the STA shown including t₃₁, as described above, the Null frame can be positioned at the head of the queue corresponding to the access category associated with the Null frame. At t₁₇, the STA1 can send an optional ACK, and then go to sleep for the interval shown as the “X-time interval” (sleep starts after the ACK at t₁₉ shown).

Following the beacon interval shown between successive Beacon Tx times (e.g., a beacon interval of 100 msec), at time t₁₈ STA1 awakes from its sleep and sends another PSPoll frame. Although not shown, before time t₁₈, there could be a beacon with TIM set for STA1. At t₁₉, the AP sends an optional ACK. At t₂₀, the AP sends a data frame having at least one data packet including location information for STA1. To minimize listening time for the STA1 including the interval shown as t₃₂, as described above, the data frame can be positioned at the head of the queue corresponding to the access category associated with the data frame. At t₂₁, the STA1 can send an optional ACK.

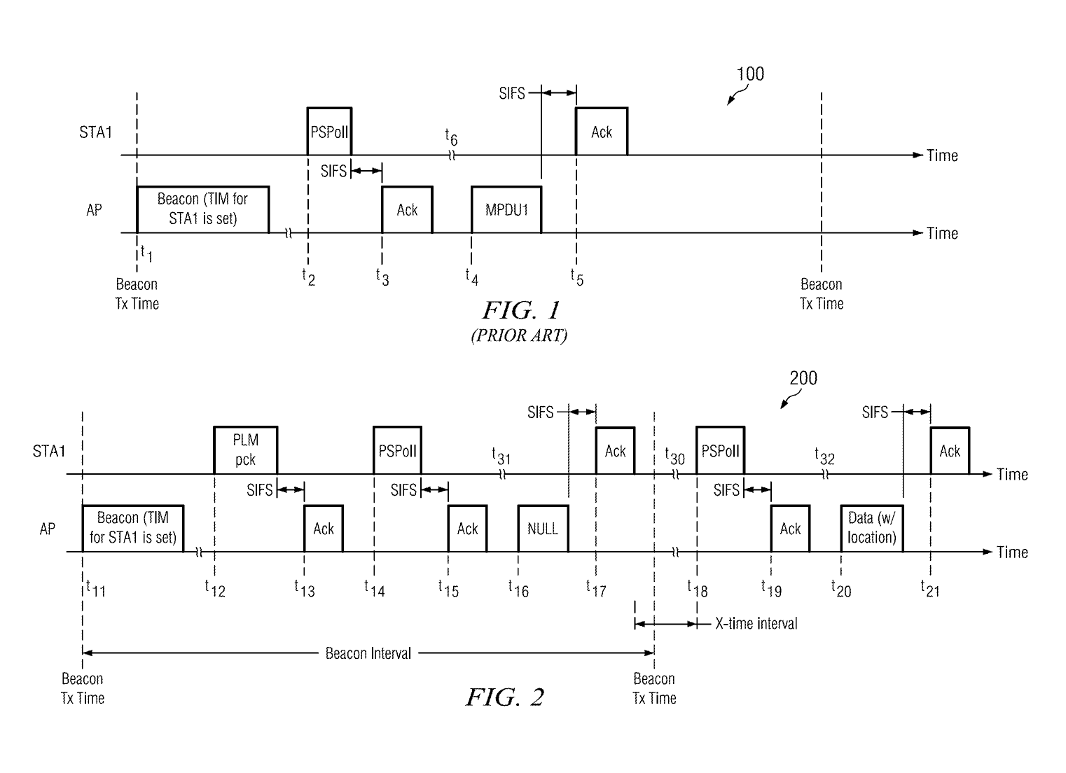

In example timing diagram 200, the STA1 will be awake (listening) only for intervals t₁₄ to t₁₇ (till end of the ACK sent at t₁₇) and t₁₈ to t₂₁ (till end of the ACK sent at t₂₁). If it is assumed that the disclosed listening period PSPoll-ACK-DATA-ACK is 25 msec, and in a worst case the sequence PSPoll-ACK-DATA-ACK is done every beacon frame (e.g., once per 100 msec beacon period/interval), a 75% saving in power consumption is achieved compared to the power expended by STA while listening in the timing diagram 100 in FIG. 1 that shows the workings of a known PSPoll mechanism which queues the location response packet from the AP at the end of the packet transmission buffers (i.e. at the end of a long queue over many beacon intervals).

In the known PSPoll mechanism (see timing diagram 100 in FIG. 1), transmission of the location response packet from the AP will occur only when this packet reaches the head of its transmission queue; i.e., all the packets queued (which could be in hundreds) before the location request packet have been transmitted successfully. For a network with at least a moderate traffic load using the known PSPoll mechanism, transmission of these many packets from the AP will require long time intervals, e.g., seconds and tens of seconds, which takes place before transmission of the location request packet. This estimation does not take into account that other STAs in the network will have to transmit their own packets to the AP, thus further delaying transmission of location request packet from the AP to STA1. Hence, STA' power consumption with the known PSPoll mechanism is much higher than that of disclosed methods.

FIG. 3A is a block diagram representation of an example AP or soft-AP 110 including a wireless transceiver and a disclosed location request scheduler 117 for responding to a PSPoll frame from a STA that provides a priority response including a data frame comprising location response packet including network-computed STA' locations or a Null frame for reducing STA' power consumption while waiting for the AP response, according to an example embodiment. AP or soft-AP 110 includes a wireless transceiver 112 and a disclosed location request scheduler 117. AP or soft-AP 110 also includes a processor 116 and associated memory 119 for implementing location request scheduler 117. AP or soft-AP 110 is also shown including an antenna 123.

FIG. 3B is a block diagram depiction of an example wireless network 350 that includes a central network server 140, a disclosed AP 110 shown as a WLAN AP 110, and a plurality of STAs, according to an example embodiment. Central network server 140 includes processor 316, memory 321, transceiver 112, and antenna 141. AP 110 is shown as a WLAN AP 110 for embodiments where the network 350 supports WLAN. Although a single AP 110 is shown, in typical wireless networks there are a plurality of APs.

The plurality of STAs in wireless network 350 are shown as STA1, STA2 320 and STA3. The network 350 can optionally include at least one soft-AP. There are at least two possible soft-AP scenarios. One scenario (not shown) involves a soft-AP and STAs forming the network without the presence of the WLAN AP 110, or as shown in FIG. 3B STA2 320 (Soft-AP) acts as a bridge between STA3, STA1 and the WLAN AP 110 (or any other STA and the WLAN AP 110).

STA2 320 includes a disclosed location request scheduler 117. STA1 and STA3 are conventional STAs that include a transceiver 112, an antenna 123, and a processor 116, which lack a disclosed location request scheduler 117. STA2 320 is thus a soft-AP that is part of a P2P network (peer-to-peer network) including STA1 and STA3, where STA2 320 functions as a soft-AP or group-owner. As disclosed above, once a PSPoll packet has been received by the WLAN AP 110 or STA2 320 when functioning as a soft-AP, the location response packet or Null frame sent to the STA is a priority response.

Although not shown, in one embodiment the STAs can comprise a wireless combination (combo) device that includes a first wireless transceiver communicating via a first wireless network and a second wireless transceiver communicating via a second wireless network that overlaps the first wireless network. For example, in one particular embodiment the first wireless network comprises a WLAN and the second wireless network comprises a wireless personal area network (WPAN). Example WPANs include Bluetooth (BT), as well as Zigbee and LTE which use the ISM band.

Many modifications and other embodiments of the invention will come to mind to one skilled in the art to which this invention pertains having the benefit of the teachings presented in the foregoing descriptions, and the associated drawings. Therefore, it is to be understood that embodiments of the invention is not to be limited to the specific embodiments disclosed. Although specific terms are employed herein, they are used in a generic and descriptive sense only and not for purposes of limitation.

We claim:

1. A method of reducing client power consumption in a wireless network including a network server which provides computed client' locations, at least one access point (AP), and a plurality of wireless stations (STAs) including a first wireless station (STA1), comprising:
said AP periodically sending beacon frames that span a beacon period, wherein at least a first beacon frame is sent during said beacon period;
said STA1 sending a location request frame to said AP requesting a STA1 location;
during said beacon period said STA1 waking up from a powersave (PS) mode or a sleep mode and sending a PSPoll frame to said AP, and
responsive to said PSPoll frame, said AP replying with a priority response comprising a data frame including a location response packet including said STA1 location or a Null frame if said STA1 location is not available.

2. The method of claim 1, wherein said priority response includes a time stamp that identifies when said STA1 location was computed.

3. The method of claim 1, wherein said Null frame or said data frame is at a head of a queue corresponding to its respective access category.

4. The method of claim 1, wherein said Null frame or said data frame is in its queue based on a time of arrival of said PSPoll frame at said AP.

5. The method of claim 1, further comprising said AP sending an acknowledgment (ACK) responsive to said PSPoll frame before transmitting said data, and said STA1 sending an ACK responsive to said AP transmitting said data frame.

6. The method of claim 1, wherein said AP responds to said PSPoll frame without an acknowledgment (ACK) before sending said priority response.

7. The method of claim 1, wherein said STA1 sending said location request frame comprises sending a path-loss measurement (PLM) packet.

8. The method of claim 1, wherein said STA1 is in said PS mode immediately before sending said PSPoll frame, and wherein said STA1 participates in wireless network communications using said wireless network while in said PS mode.

9. The method of claim 1, wherein said priority response includes a time stamp that identifies when said STA1 location was computed, further comprising having said STA1 go to sleep if said priority response is a Null frame or said time stamp indicates said STA1 location was computed prior to a most recent path-loss measurement (PLM) packet sent by said STA1.

10. The method of claim 1, wherein at least one of said plurality of STAs functions in said wireless network as said AP (a soft-AP).

11. A wireless access point (AP) for operation in a wireless network including a central network server and a plurality of STAs including a first wireless station (STA1), said AP comprising:
a first wireless transceiver coupled to an antenna configured for communication via a first wireless network over at least a first band, and
a processor implementing:
(i) periodically sending beacon frames that span a beacon period, wherein at least a first beacon frame is sent during said beacon period, and
(ii) a location request scheduler coupled to said first wireless transceiver that is responsive to a PSPoll frame received for said STA1 that during said beacon period wakes up from a powersave (PS) mode or a sleep mode and sends a PSPoll frame to said AP replies with a priority response comprising a data frame including a location response packet including a location of said STA1 (STA1 location) or a Null frame if said STA1 location is not available.

12. The AP of claim 11, wherein said priority response includes a time stamp that identifies when said STA1 location was computed.

13. The AP of claim 11, wherein said Null frame or said data frame is at a head of a queue corresponding to its respective access category.

14. The AP of claim 11, wherein said Null frame or said data frame is in its queue based on a time of arrival of said PSPoll frame at said AP.

15. A wireless network, comprising:
a central network server;
an access point (AP);
a plurality of STAs including a first wireless station (STA1),
wherein said AP comprises:
a first wireless transceiver coupled to an antenna configured for communication via a first wireless network over at least a first band, and
a processor implementing:
(i) periodically sending beacon frames that span a beacon period, wherein at least a first beacon frame is sent during said beacon period, and
(ii) a location request scheduler coupled to said first wireless transceiver that is responsive to a PSPoll frame received for said STA1 that during said beacon period wakes up from a powersave (PS) mode or a sleep mode and sends a PSPoll frame to said AP replies with a priority response comprising a data frame including a location response packet including a location of said STA1 (STA1 location) or a Null frame if said STA1 location is not available.

16. The wireless network of claim 15, wherein said wireless network is a wireless local area network (WLAN).

17. The wireless network of claim 15, wherein said priority response includes a time stamp that identifies when said STA1 location was computed.

18. The wireless network of claim 15, wherein said Null frame or said data frame is at a head of a queue corresponding to its respective access category.

19. The wireless network of claim 15, wherein said Null frame or said data frame is in its queue based on a time of arrival of said PSPoll frame at said AP.

20. The wireless network of claim 15, wherein at least one of said plurality of STAs includes said processor including said location request scheduler that functions in said wireless network as said AP (a soft-AP).
